(19) United States
(12) Patent Application Publication
(10) Pub. No.: US 2020/0272325 A1
(43) Pub. Date: Aug. 27, 2020

(54) INPUT CONTROL DEVICE, INPUT DEVICE, AND INPUT CONTROL METHOD

(71) Applicant: MITSUBISHI ELECTRIC CORPORATION, Tokyo (JP)

(72) Inventors: Yuki FURUMOTO, Tokyo (JP); Kimika IKEGAMI, Tokyo (JP)

(73) Assignee: MITSUBISHI ELECTRIC CORPORATION, Tokyo (JP)

(21) Appl. No.: 16/646,952

(22) PCT Filed: Oct. 11, 2017
(86) PCT No.: PCT/JP2017/036776

§ 371 Date: Mar. 12, 2020

(51) Int. Cl. G06F 3/0488; G06F 3/041; B60K 35/00

(52) U.S. Cl. CPC G06F 3/04886; G06F 3/0412; B60K 2370/182; G06F 2203/04803; B60K 2370/1438; B60K 35/00

(57) ABSTRACT

An attribute acquiring unit (12) acquires pieces of area information indicating multiple split areas into which the screen of a display (42) equipped with a touch sensor (22) is split, and attribution information for each of the multiple split areas. An area specifying unit (14) specifies a split area including the position of an operation device (21) detected by a position detecting unit (11) by using the pieces of area information acquired by the attribute acquiring unit (12). An action specifying unit (15) specifies an action corresponding to details of an operation performed on the operation device (21), the details being detected by an operation detail detecting unit (13), by using the attribution information corresponding to the split area specified by the area specifying unit (14), and outputs information indicating the action to an HMI control unit (31).

### TECHNICAL FIELD

The present disclosure relates to an input control device, an input device, and an input control method that use an operation device operated on a display integral with a touch sensor (referred to as a “touch-sensor-equipped display” hereinafter).

### BACKGROUND ART

Because touch-sensor-equipped displays do not have projections and depressions on surfaces thereof, users need to operate a touch sensor while viewing a display. On the other hand, in a case of a touch-sensor-equipped display including an operation device, users can intuitively operate the operation device mounted on the touch-sensor-equipped display without viewing the display. To the above-mentioned operation device, an action that is an operation target is assigned. In a case in which one action is assigned to one operation device, multiple operation devices need to be mounted on the touch-sensor-equipped display in order to make it possible for multiple actions to be performed. On the other hand, in a case in which multiple actions are assigned to one operation device, users need to perform an operation of switching between actions.

For example, an operation information input system according to Patent Literature 1 includes an operation device having a structure in which an upper layer device and a lower layer device are layered. To the lower layer device, for example, an action of enlarging or reducing a map currently being displayed on the screen is assigned. To the upper layer device, an action of selecting a content existing in a map currently being displayed on the screen is assigned. On a touch-sensor-equipped display on which a map is displayed, a user moves the lower layer device to a point in which the user is interested, and then rotates the lower layer device at the position of the point to display an enlarged or reduced map. After that, by rotating the upper layer device after laying the upper layer device on the lower layer device, the user sequentially switches between contents existing in the displayed enlarged or reduced map. As mentioned above, by assigning different actions to the upper layer device and the lower layer device, the operation information input system according to Patent Literature 1 can perform two actions by using the single operation device.

### CITATION LIST

### Patent Literature

Patent Literature 1: JP 2013-178678 A

### SUMMARY OF INVENTION

### Technical Problem

However, the operation device of Patent Literature 1 has a problem in which the operation of switching between actions is complicated, for example, there is a necessity to separately handle the upper layer device and the lower layer device. Further, the invention according to Patent Literature 1 has a problem in which the position of the operation device and content currently being displayed on the screen need to be linked to each other.

The present disclosure is made in order to solve the above-mentioned problems, and it is therefore an object of the present disclosure to provide a technique for making it possible to easily switch between multiple actions by using a single operation device, and to switch to an action that is unrelated to content currently being displayed on the screen.

### Solution to Problem

An input control device according to the present disclosure includes: a position detecting unit for detecting the position of an operation device on a touch-sensor-equipped display; an attribute acquiring unit for acquiring pieces of area information indicating respective multiple split areas into which the screen of the touch-sensor-equipped display is split, and attribution information for each of the multiple split areas; an operation detail detecting unit for detecting details of an operation performed on the operation device; an area specifying unit for specifying one of the split areas which includes the position of the operation device detected by the position detecting unit by using the pieces of area information acquired by the attribute acquiring unit; and an action specifying unit for specifying an action corresponding to the details of the operation detected by the operation detail detecting unit by using the attribution information corresponding to the split area specified by the area specifying unit.

### Advantageous Effects of Invention

According to the present disclosure, because an action corresponding to the details of an operation on the operation device is specified using the attribution information corresponding to the split area including the position of the operation device, it is possible to easily switch between multiple actions by using the single operation device. Further, because the position of the operation device and content currently being displayed on the screen of the touch-sensor-equipped display do not necessarily have to be linked to each other, it is possible to switch to an action that is unrelated to the content currently being displayed on the screen.

### BRIEF DESCRIPTION OF DRAWINGS

FIG. 1 is a block diagram showing an example of the configuration of a vehicle information system according to Embodiment 1;

FIG. 2 shows an example of a rotary operation device in Embodiment 1, FIG. 2A is a side view, and FIG. 2B is a rear view;

FIG. 3 shows an example of the structure of the rotary operation device in Embodiment 1, FIG. 3A is a side view when no push operation is performed, FIG. 3B is a rear view when no push operation is performed, and FIG. 3C is a rear view when a push operation is performed;

FIG. 4 shows an example of the structure of the rotary operation device in Embodiment 1, FIG. 4A is a side view, and FIG. 4B is a rear view;

FIG. 5 shows an example of the structure of a sliding operation device in Embodiment 1, FIG. 5A is a side view, and FIG. 5B is a rear view;

FIG. 6 shows an example of the structure of the sliding operation device in Embodiment 1, FIG. 6A is a side view, and FIG. 6B is a rear view;

FIG. 7 is a diagram explaining an example of screen splitting in Embodiment 1;

FIG. 8 is a diagram explaining an example of the screen splitting in Embodiment 1;

FIG. 9 is a diagram explaining an example of the screen splitting in Embodiment 1;

FIG. 10 is a diagram explaining an example of the screen splitting in Embodiment 1;

FIG. 11 is a diagram explaining an example of the screen splitting in Embodiment 1;

FIG. 12 is a diagram showing an example of a table held by an area splitting unit in Embodiment 1;

FIG. 13 is a diagram showing an example of a table held by the area splitting unit in Embodiment 1;

FIG. 14 is a diagram showing an example of a table held by an action specifying unit in Embodiment 1;

FIG. 15 is a diagram showing an example of a table held by the action specifying unit in Embodiment 1;

FIG. 16 is a diagram showing an example of a table held by the action specifying unit in Embodiment 1;

FIG. 17 is a flow chart explaining an example of the operation of an input control device according to Embodiment 1, and shows a case in which the operation device shown in FIG. 2, 3, or 5 is used;

FIG. 18 is a flow chart explaining an example of the operation of the input control device according to Embodiment 1, and shows a case in which the operation device shown in FIG. 4 or 6 is used;

FIG. 19 is a block diagram showing an example of the configuration of a vehicle information system according to Embodiment 2;

FIG. 20 is a flow chart explaining an example of the operation of an input control device according to Embodiment 2, and shows a case in which the operation device shown in FIG. 2, 3, or 5 is used;

FIG. 21 is a flow chart explaining an example of the operation of the input control device according to Embodiment 2, and shows a case in which the operation device shown in FIG. 4 or 6 is used; and

FIGS. 22A and 22B are diagrams showing examples of the hardware configuration of the vehicle information system according to each embodiment.

### DESCRIPTION OF EMBODIMENTS

Hereinafter, in order to explain the present disclosure in greater detail, embodiments of the present disclosure will be described with reference to the accompanying drawings.

### Embodiment 1

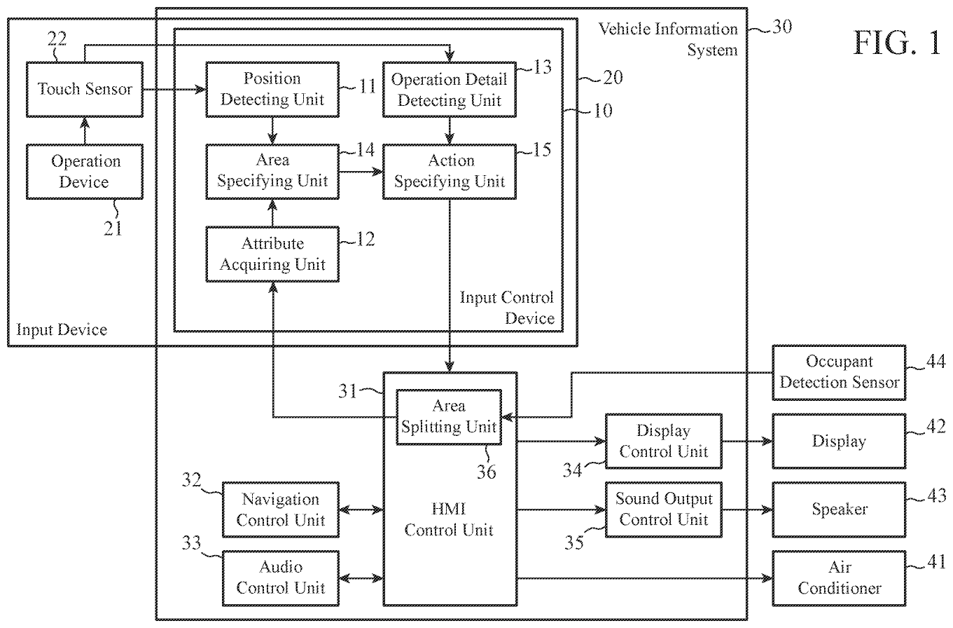

FIG. 1 is a block diagram showing an example of the configuration of a vehicle information system 30 according to Embodiment 1. The vehicle information system 30 is mounted in a vehicle, and includes a position detecting unit 11, an attribute acquiring unit 12, an operation detail detecting unit 13, an area specifying unit 14, an action specifying unit 15, a human machine interface (HMI) control unit 31, a navigation control unit 32, an audio control unit 33, a display control unit 34, a sound output control unit 35, and an area splitting unit 36. Further, the vehicle information system 30 is connected to a touch sensor 22, an air conditioner 41, a display 42, a speaker 43, and an occupant detection sensor 44 that are mounted in the vehicle. The position detecting unit 11, the attribute acquiring unit 12, the operation detail detecting unit 13, the area specifying unit 14, and the action specifying unit 15 are included in an input control device 10. The input control device 10, an operation device 21, and the touch sensor 22 are included in an input device 20.

The vehicle information system 30 according to Embodiment 1 performs an action corresponding to details of an occupant's operation on the operation device 21 which is in contact with a position on the screen of the display 42 integral with the touch sensor 22 of capacitance type or pressure-sensitive type (referred to as the “display 42 equipped with the touch sensor 22” hereinafter). This display 42 equipped with the touch sensor 22 is used as, for example, a center information display (CID).

Hereinafter, an example in which the touch sensor 22 of capacitance type is used will be explained.

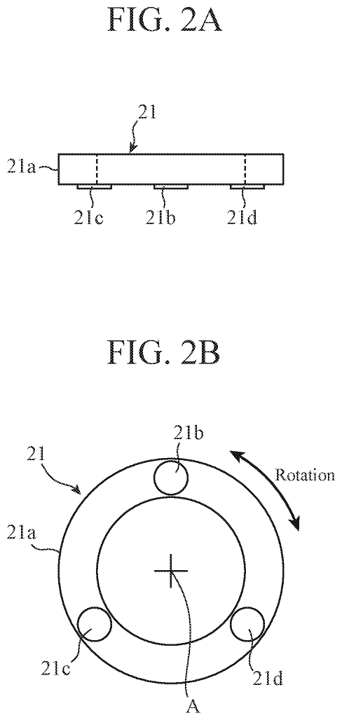

First, examples of the structure of the operation device 21 will be explained using FIGS. 2 to 6.

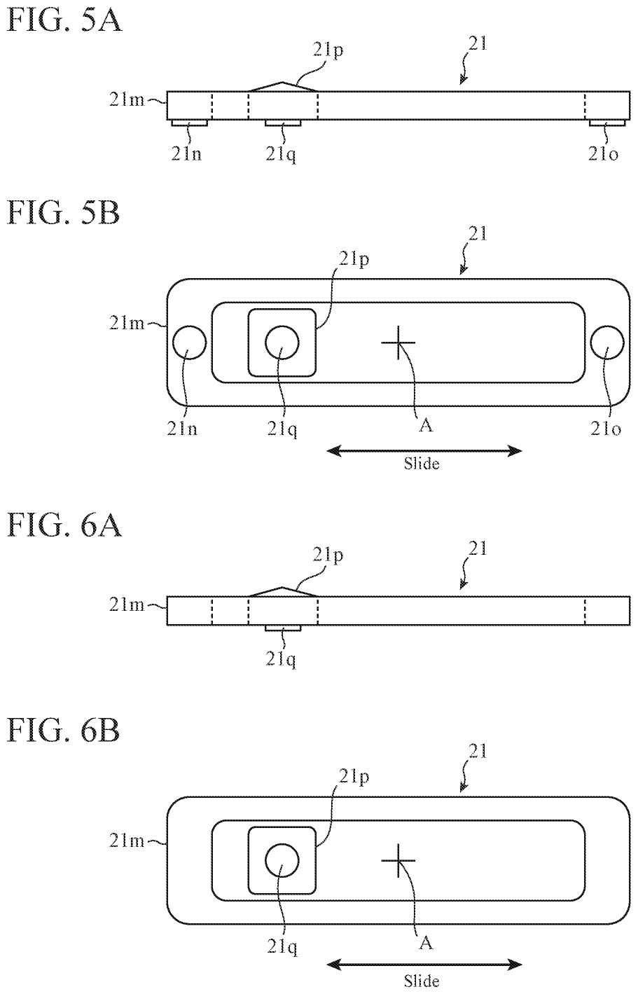

The operation device 21 shown in each of FIGS. 2, 3, and 4 is structured to be able to move on the screen of the display 42 equipped with the touch sensor 22 and to be rotationally operated or push-operated at a position to which the operation device has moved. The operation device 21 shown in each of FIGS. 5 and 6 is structured to be able to move on the screen of the display 42 equipped with the touch sensor 22 and to be slide-operated at a position to which the operation device has moved.

FIG. 2 shows an example of the structure of the operation device 21 in Embodiment 1 that is of rotary type, FIG. 2A is a side view, and FIG. 2B is a rear view. The operation device 21 shown in FIG. 2 includes a ring-shaped rotation operation portion 21a made of a conductive material, and contact portions 21b, 21c, and 21d each of which is made of a conductive material and projects from a rear surface of the rotation operation portion 21a. When an occupant's hand touches the rotation operation portion 21a in a state in which the contact portions 21b, 21c, and 21d are in contact with the display 42 equipped with the touch sensor 22, static electricity with which the rotation operation portion 21a is charged is conducted to the contact portions 21b, 21c, and 21d. Thereby, the contact portions 21b, 21c, and 21d are detected by the touch sensor 22.

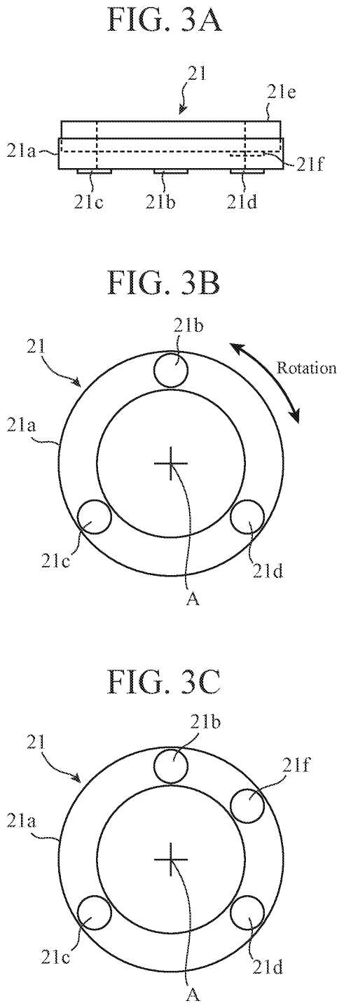

FIG. 3 shows an example of the structure of the operation device 21 in Embodiment 1 that is of rotary type, FIG. 3A is a side view when no push operation is performed, FIG. 3B is a rear view when no push operation is performed, and FIG. 3C is a rear view when a push operation is performed. The operation device 21 shown in FIG. 3 includes a push operation portion 21e that can move in upward and downward directions with respect to a rotation operation portion 21a, and a contact portion 21f that projects from a rear surface of the push operation portion 21e. The push operation portion 21e and the contact portion 21f are each made of a conductive material. Further, the rotation operation portion 21a and the push operation portion 21e are partially in contact with each other, and thus static electricity with which either one of the portions is charged is conducted to the other one of the portions. When an occupant's hand touches the rotation operation portion 21a or the push operation portion 21e in a state in which contact portions 21b, 21c, and 21d are in contact with the display 42 equipped with the touch sensor 22, the contact portions 21b, 21c, and 21d are detected by the touch sensor 22. Further, when an occupant's hand push-operates the push operation portion 21e, the contact portion 21f comes into contact with the display 42 equipped with the touch sensor 22 and is thereby detected by the touch sensor 22.

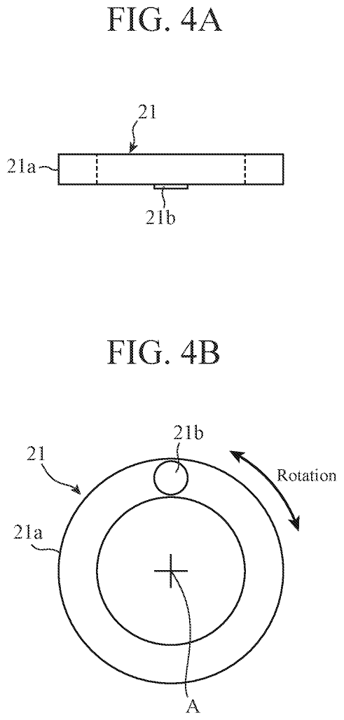

FIG. 4 shows an example of the structure of the operation device 21 in Embodiment 1 that is of rotary type, FIG. 4A is a side view, and FIG. 4B is a rear view. In contrast with the operation device 21 shown in FIG. 2 including the three contact portions 21b, 21c, and 21d, the operation device 21 shown in FIG. 4 includes a single contact portion 21b. Except for that difference, both have the same structure. The operation device 21 shown in FIG. 4 may include a push operation portion 21e and a contact portion 21f which are shown in FIG. 3.

FIG. 5 shows an example of the structure of the operation device 21 in Embodiment 1 that is of sliding type, FIG. 5A is a side view, and FIG. 5B is a rear view. The operation device 21 shown in FIG. 5 includes a rectangular frame portion 21m made of a conductive material, and a slide operation portion 21p that is made of a conductive material and that can slide in an inner opening part of the frame portion 21m. Both short side parts of the frame portion 21m are supported on a left side part and a right side part of the display 42 equipped with the touch sensor 22 in such a way that the short side parts can move in upward and downward directions, and thereby the slide operation portion 21p can move on the entire screen surface of the display 42 equipped with the touch sensor 22. As an alternative, both the short side parts of the frame portion 21m are supported on an upper side part and a lower side part of the display 42 equipped with the touch sensor 22 in such a way that the short side parts can move in rightward and leftward directions, and thereby the slide operation portion 21p can move on the entire screen surface of the display 42 equipped with the touch sensor 22. On rear surfaces of the frame portion 21m and the slide operation portion 21p, contact portions 21n, 21o, and 21q each made of a conductive material are provided. The frame portion 21m and the slide operation portion 21p are partially in contact with each other, and thus static electricity with which the slide operation portion 21p is charged is conducted to the frame portion 21m. When an occupant's hand touches the slide operation portion 21p in a state in which the contact portions 21n, 21o, and 21q are in contact with the display 42 equipped with the touch sensor 22, static electricity with which the slide operation portion 21p is charged is conducted to the contact portions 21n, 21o, and 21q. Thereby, the contact portions 21n, 21o, and 21q are detected by the touch sensor 22.

FIG. 6 shows an example of the structure of the operation device in Embodiment 1 that is of sliding type, FIG. 6A is a side view, and FIG. 6B is a rear view. In contrast with the operation device 21 shown in FIG. 5 including the contact portions 21n and 210 on the frame portion 21m, the operation device 21 shown in FIG. 6 does not include the contact portions 21n and 21o. Except for that difference, both have the same structure.

Next, the details of the vehicle information system 30 will be explained.

The touch sensor 22 detects the one or more contact portions that the operation device 21 includes, and outputs a result of the detection to the position detecting unit 11 and the operation detail detecting unit 13.

The position detecting unit 11 receives the detection result from the touch sensor 22. The position detecting unit 11 detects the position of the operation device 21 on the screen of the display 42 equipped with the touch sensor 22 by using the received detection result, and outputs position information to the area specifying unit 14.

For example, the position detecting unit 11 detects the center of gravity of the triangle formed by the three contact portions 21b, 21c, and 21d of the operation device 21 shown in each of FIGS. 2 and 3, and defines the center of gravity as the position A of the operation device 21. Instead, for example, the position detecting unit 11 detects the center of the rotation operation portion 21a from the locus of rotation of the contact portion 21b of the operation device 21 shown in FIG. 4, and defines the center as the position A of the operation device 21. Instead, for example, the position detecting unit 11 detects the center of the two contact portions 21n and 210 shown in FIG. 5, and defines the center as the position A of the operation device 21. Instead, for example, the position detecting unit 11 detects the center of the frame portion 21m from the locus of a slide of the contact portion 21q of the operation device 21 shown in FIG. 6, and defines the center as the position A of the operation device 21.

The attribute acquiring unit 12 acquires pieces of area information indicating multiple split areas into which the screen of the display 42 equipped with the touch sensor 22 is split and attribution information for each of the split areas from the area splitting unit 36 of the HMI control unit 31. Each piece of area information indicates the position and the size of the corresponding split area. Each piece of attribution information indicates an action linked to the corresponding split area, or indicates content currently being displayed in the corresponding split area. Actions include a function that is related to navigation and that the navigation control unit 32 performs, a function that is related to AV playback and that the audio control unit 33 performs, a function that is related to the air conditioner 41 and that the HMI control unit 31 performs, etc., which will be mentioned later, and application ranges within which these functions are to be performed. The application ranges are, for example, a driver's seat, a front seat next to the driver, a left rear seat, and a right rear seat, in the case of vehicles. The attribute acquiring unit 12 outputs the pieces of area information and the pieces of attribution information that the attribute acquiring unit has acquired to the area specifying unit 14.

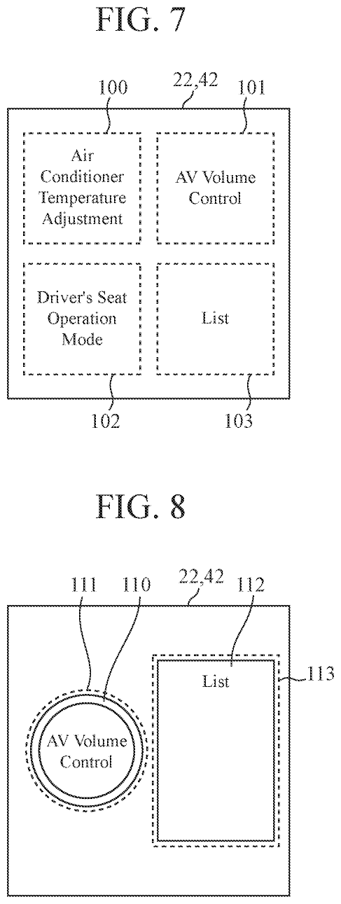

FIGS. 7 to 11 are diagrams explaining examples of the screen splitting in Embodiment 1.

In the display 42 equipped with the touch sensor 22 shown in FIG. 7, the screen is split into four split areas: an air conditioner temperature adjustment area 100, an audio visual (AV) volume control area 101, a driver's seat operation mode area 102, and a list area 103. For example, the area information for the air conditioner temperature adjustment area 100 indicates the position and the size of the air conditioner temperature adjustment area 100 in the screen. Further, the attribution information for the air conditioner temperature adjustment area 100 indicates that an air conditioner temperature adjustment function is linked to this split area.

Content currently being displayed on the screen and the attribution information for each split area may be in agreement with each other, or do not have to be in agreement with each other. Particularly, in a scene in which the driver or the like operates the operation device 21 without viewing the screen, the necessity of causing both the content and the attribution information to be in agreement with each other is low. As a case in which both the content and the attribution information are in agreement with each other, for example, in FIG. 7, a display object for temperature adjustment is displayed in the air conditioner temperature adjustment area 100, a display object for AV volume control is displayed in the AV volume control area 101, a driver's seat operation mode screen is displayed in the driver's seat operation mode area 102, and a list is displayed in the list area 103. Further, as a case in which both the content and the attribution information are not in agreement with each other, for example, the entire screen is split, as shown in FIG. 7, into the four areas: the air conditioner temperature adjustment area 100, the AV volume control area 101, the driver's seat operation mode area 102, and the list area 103, and a map or the like unrelated to each split area is displayed on the screen.

On the screen shown in FIG. 8, a display object 110 for AV volume control and a list display object 112, such as a list of song titles, are displayed. On this screen, an AV volume control area 111 is generated by splitting in such a way as to match a display area of the display object 110, and a list area 113 is generated by splitting in such a way as to match a display area of the list display object 112.

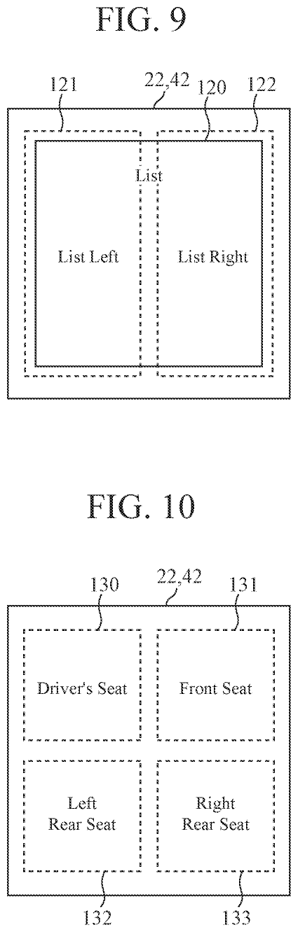

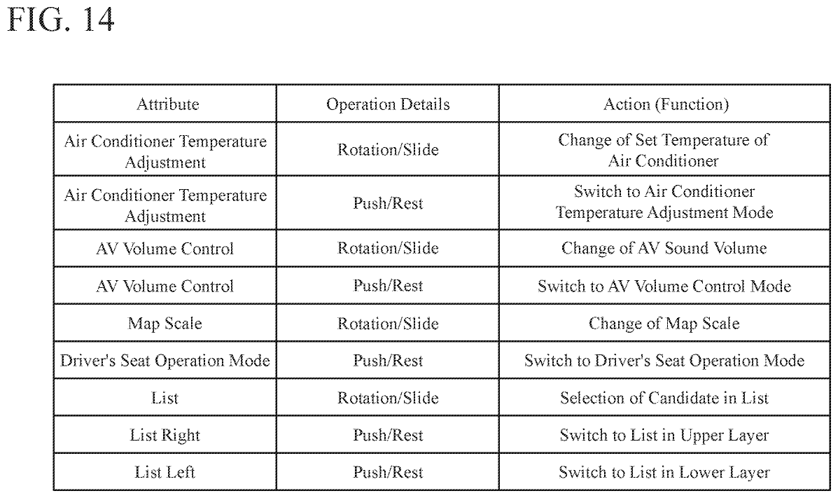

On the screen shown in FIG. 9, a list display object 120, such as a list of song titles, is displayed. On this screen, a display area of the list display object 120 is split into a list left area 121 and a list right area 122. To the list left area 121 or the list right area 122, an attribute such as “list left” or “list right” for switching the display from the list currently being displayed to a list in a lower or upper layer is linked, as will be mentioned later using FIG. 14.

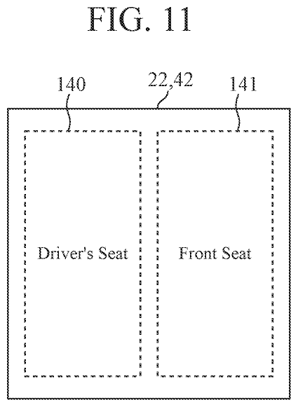

The screen shown in FIG. 10 is split into a driver's seat area 130, a front seat area 131, a left rear seat area 132, and a right rear seat area 133. The screen shown in FIG. 11 is split into a driver's seat area 140 and a front seat area 141. For example, the attribution information for each of the driver's seat areas 130 and 140 indicates the driver's seat that is the application range of a function that the HMI control unit 31 or the like performs.

In the examples of FIGS. 10 and 11, each of the driver's seat areas 130 and 140 is provided on the left side of the screen because the driver's seat is located to the left of the display 42 equipped with the touch sensor 22. In a case in which the driver's seat is located to the right of the display 42 equipped with the touch sensor 22, each of the driver's seat areas 130 and 140 is provided on the right side of the screen.

In a case in which the display 42 equipped with the touch sensor 22 is used as a CID, each of occupants in the driver's seat, the front seat next to the driver, the left rear seat, and the right rear seat can operate the operation device 21. In this case, splitting is performed in such a way that an area of the screen closest to the driver's seat is the driver's seat area 130, an area of the screen closest to the front seat next to the driver is the front seat area 131, an area of the screen closest to the left rear seat is the left rear seat area 132, and an area of the screen closest to the right rear seat is the right rear seat area 133. Thereby, each occupant can intuitively grasp the occupant's split area corresponding to the application range.

The operation detail detecting unit 13 receives the detection result from the touch sensor 22. The operation detail detecting unit 13 detects details of an operation that an occupant has performed on the operation device 21 by using the received detection result, and outputs operation detail information to the action specifying unit 15. The details of the operation include, for example, a rotational operation on the rotation operation portion 21a, a push operation on the push operation portion 21e, a slide operation on the slide operation portion 21p, or a rest operation of keeping the operation device 21 at rest during a predetermined time period in a state in which a hand is touching the operation device 21.

The area specifying unit 14 receives the position information from the position detecting unit 11, and receives the pieces of area information and the pieces of attribution information from the attribute acquiring unit 12. The area specifying unit 14 specifies the split area including the position of the operation device 21 by using the position information and the pieces of area information. The area specifying unit 14 outputs the attribution information corresponding to the specified split area to the action specifying unit 15.

The action specifying unit 15 receives the operation detail information from the operation detail detecting unit 13, and receives the attribution information from the area specifying unit 14. The action specifying unit 15 specifies an action corresponding to the operation details by using the attribution information, and outputs information indicating the specified action to the HMI control unit 31. The details of the action specifying unit 15 will be mentioned later.

The HMI control unit 31 receives the information indicating the action or information indicating the action and an operation amount from the action specifying unit 15. The HMI control unit 31 acts for itself in accordance with the received information, or outputs the received information to the navigation control unit 32 or the audio control unit 33. The HMI control unit 31 determines, on the basis of a result of its own action or a result of the action of the navigation control unit 32 or the audio control unit 33, content to be displayed on the screen of the display 42 or content to be outputted by voice from the speaker 43, and outputs the content to the display control unit 34 or the sound output control unit 35.

The area splitting unit 36 splits the screen of the display 42 equipped with the touch sensor 22 into multiple split areas. The area splitting unit 36 generates area information and attribution information for each of the split areas after splitting, and outputs the generated area information and the generated attribution information to the attribute acquiring unit 12.

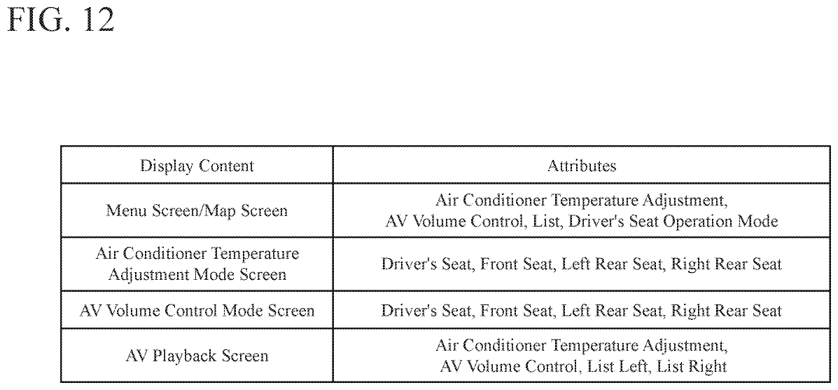

FIG. 12 is a diagram showing an example of a table held by the area splitting unit 36 in Embodiment 1. The area splitting unit 36 holds the table showing a correspondence between display content and attributes. For example, when a menu screen is to be displayed on the display 42 or when map information received from the navigation control unit 32 is to be displayed as a map screen on the display 42, the area splitting unit 36 splits the screen into four split areas and links attributes “air conditioner temperature adjustment”, “AV volume control”, “list”, and “driver's seat operation mode” to the respective split areas by using the table of FIG. 12. The area splitting unit 36 then outputs the pieces of area information and the pieces of attribution information for the split areas to the attribute acquiring unit 12. As previously explained, display content may be or do not have to be in agreement with the split areas and the attributes.

Further, for example, the area splitting unit 36 may receive a result of occupant detection from the occupant detection sensor 44, and set a split area only for a seat where an occupant is sitting in accordance with the position of the seat. For example, in a case in which display content is an “air conditioner temperature adjustment mode screen”, the area splitting unit 36 splits the screen into two areas: a “driver's seat area” and a “front seat area” when two occupants are sitting in the driver's seat and the front seat next to the driver, and splits the screen into four areas: a “driver's seat area”, a “front seat area”, a “left rear seat area”, and a “right rear seat area” when four occupants are sitting in the driver's seat, the front seat next to the driver, the left rear seat, and the right rear seat.

As an alternative, the area splitting unit 36 may set split areas in accordance with an application range where an action can be performed. For example, in a case of a vehicle in which air vents of the air conditioner 41 are provided only for the driver's seat and the front seat next to the driver, the area splitting unit 36 splits the “air conditioner temperature adjustment mode screen” into two areas: a “driver's seat area” and a “front seat area”, and in a case of a vehicle in which air vents of the air conditioner 41 are provided for the driver's seat, the front seat next to the driver, the left rear seat, and the right rear seat, the area splitting unit 36 splits the “air conditioner temperature adjustment mode screen” into four areas: a “driver's seat area”, a “front seat area”, a “left rear seat area”, and a “right rear seat area.”

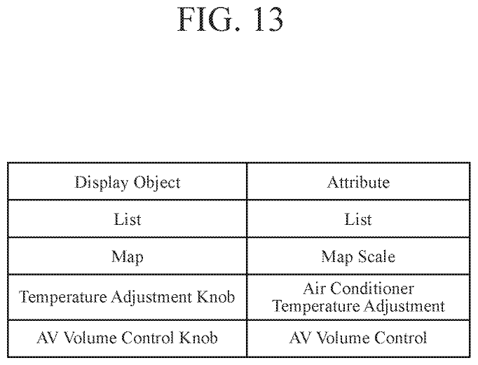

FIG. 13 is a diagram showing an example of a table held by the area splitting unit 36 in Embodiment 1. The area splitting unit 36 holds the table showing a correspondence between display objects and attributes. When a list of a facility search result received from the navigation control unit 32, a list of song titles received from the audio control unit 33, or the like is to be displayed on the display 42, the area splitting unit 36 splits the screen to generate an area in which the “list” is to be displayed by using the table of FIG. 13, and generates area information and attribution information for the split area.

FIG. 14 is a diagram showing an example of a table held by the action specifying unit 15 in Embodiment 1. The action specifying unit 15 holds the table showing a correspondence between attributes, operation details, and actions. The action specifying unit 15 specifies an action that matches the attribution information and the operation detail information by reference to this table.

For example, when an occupant moves the operation device 21 to the air conditioner temperature adjustment area 100 in FIG. 7 and performs a rotational operation on the operation device 21, the action specifying unit 15 specifies an action of “changing the set temperature of the air conditioner” by using the table of FIG. 14. The action specifying unit 15 outputs information indicating both the specified action and a rotational operation amount to the HMI control unit 31. When receiving the information indicating “changing the set temperature of the air conditioner” from the action specifying unit 15, the HMI control unit 31 controls the air conditioner 41 to change the set temperature of the air conditioner 41 in accordance with the rotational operation amount. Further, when an occupant moves the operation device 21 to the air conditioner temperature adjustment area 100 in FIG. 7 and performs a push operation on the operation device 21, the action specifying unit 15 specifies an action of “switching to an air conditioner temperature adjustment mode” by using the table of FIG. 14. The action specifying unit 15 outputs information indicating the specified action to the HMI control unit 31. When receiving the information indicating “switching to the air conditioner temperature adjustment mode” from the action specifying unit 15, the HMI control unit 31 controls the display control unit 34 to display an air conditioner temperature adjustment mode screen on the display 42.

Further, when receiving information indicating “changing the AV sound volume” and an operation amount from the action specifying unit 15, the HMI control unit 31 controls the sound output control unit 35 to change the sound volume of the speaker 43 in accordance with the operation amount. Further, when receiving information indicating “switching to an AV volume control mode” from the action specifying unit 15, the HMI control unit 31 controls the display control unit 34 to display an AV volume control mode screen on the display 42.

Further, when receiving information indicating “switching to a driver's seat operation mode” from the action specifying unit 15, the HMI control unit 31 controls the display control unit 34 to display a driver's seat operation mode screen on the display 42. On the driver's seat operation mode screen, a display object showing an action or the like that the driver causes the vehicle information system 30 to perform, such as a display object for air conditioner temperature adjustment, is displayed.

Further, when receiving information indicating “selection of a candidate in a list”, such as a song title, from the action specifying unit 15, the HMI control unit 31 outputs an instruction to switch to the selected song title or the like to the audio control unit 33. Further, when receiving information indicating “switching to a list in an upper layer” from the action specifying unit 15, the HMI control unit 31 acquires a list in an upper layer than the list currently being displayed from the audio control unit 33, and controls the display control unit 34 to display the acquired list on the display 42.

FIG. 15 is a diagram showing an example of a table held by the action specifying unit 15 in Embodiment 1. When the air conditioner temperature adjustment mode is being performed by the HMI control unit 31, the action specifying unit 15 specifies an action that matches the attribution information and the operation detail information by reference to the table shown in FIG. 15.

For example, when an occupant moves the operation device 21 to the driver's seat area 130 in FIG. 10 and performs a rotational operation on the operation device 21, the action specifying unit 15 specifies an action of “changing the set temperature of the air conditioner for the driver's seat” by using the table of FIG. 15. The action specifying unit 15 outputs information indicating the specified action and a rotational operation amount to the HMI control unit 31. When receiving the information indicating “changing the set temperature of the air conditioner for the driver's seat” from the action specifying unit 15, the HMI control unit 31 controls the air conditioner 41 to change the set temperature of the air vent for the driver's seat of the air conditioner 41 in accordance with the rotational operation amount.

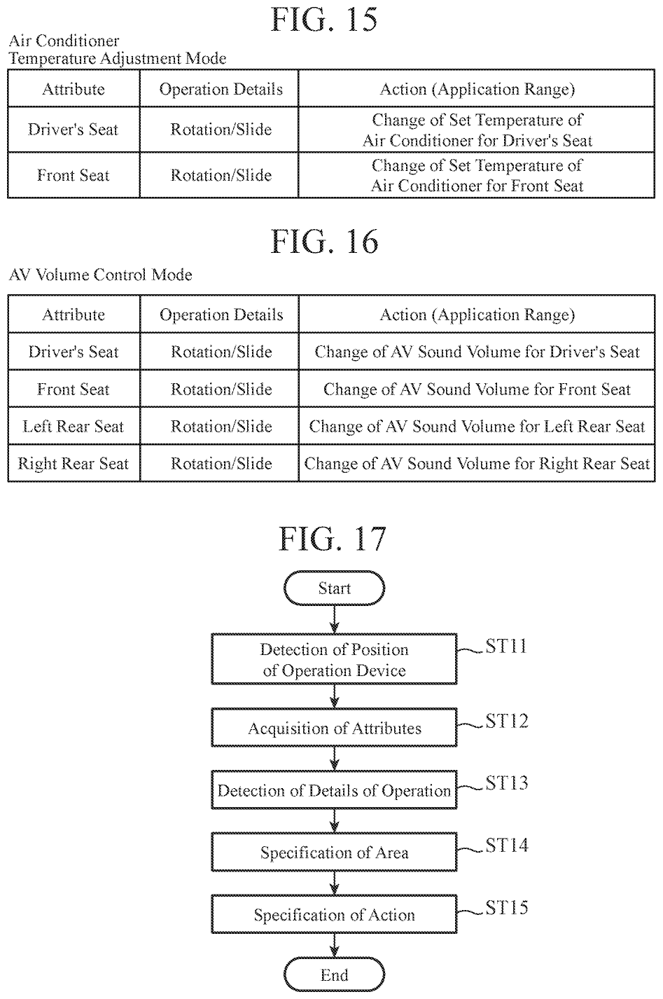

FIG. 16 is a diagram showing an example of a table held by the action specifying unit 15 in Embodiment 1. When the AV volume control mode is being performed by the HMI control unit 31, the action specifying unit 15 specifies an action that matches the attribution information and the operation detail information by reference to the table shown in FIG. 16.

For example, when an occupant moves the operation device 21 to the driver's seat area 130 in FIG. 10 and performs a rotational operation on the operation device 21, the action specifying unit 15 specifies an action of “changing the AV sound volume for the driver's seat” by using the table of FIG. 16. The action specifying unit 15 outputs information indicating the specified action and a rotational operation amount to the HMI control unit 31. When receiving the information indicating “changing the AV sound volume for the driver's seat” from the action specifying unit 15, the HMI control unit 31 controls the sound output control unit 35 to change the sound volume of the speaker 43 for the driver's seat in accordance with the rotational operation amount.

The navigation control unit 32 performs an action related to navigation, such as map display, a facility search, and route guidance, in accordance with an instruction from the HMI control unit 31. The navigation control unit 32 outputs screen information, sound information, or the like that is a result of the action to the HMI control unit 31.

The audio control unit 33 performs an action related to AV playback, such as an action of generating sound information by performing a process of playing back a song stored in a not-illustrated storage medium, and an action of generating sound information by processing a radio broadcast wave, in accordance with an instruction from the HMI control unit 31. The audio control unit 33 outputs the sound information or the like that is a result of the action to the HMI control unit 31.

The display control unit 34 controls display by the display 42 in accordance with an instruction from the HMI control unit 31.

The sound output control unit 35 controls sound output of the speaker 43 in accordance with an instruction from the HMI control unit 31.

The occupant detection sensor 44 is a camera, a weight scale, a driver monitoring system (DMS), or the like. The occupant detection sensor 44 detects whether or not an occupant is sitting in each seat, and outputs a result of the occupant detection to the area splitting unit 36.

Next, the operation of the input control device 10 according to Embodiment 1 will be explained.

FIG. 17 is a flow chart explaining an example of the operation of the input control device 10 according to Embodiment 1, and shows a case in which the operation device 21 shown in FIG. 2, 3, or 5 is used. The input control device 10 repeatedly performs the operation shown in the flow chart of FIG. 17.

In step ST11, the position detecting unit 11 detects the position of the operation device 21 on the display 42 equipped with the touch sensor 22 on the basis of the positions of the multiple contact portions that the operation device 21 includes.

In step ST12, the attribute acquiring unit 12 acquires the pieces of area information indicating the multiple split areas into which the screen of the display 42 equipped with the touch sensor 22 is split, and the attribution information for each of the multiple split areas from the area splitting unit 36 of the HMI control unit 31.

In step ST13, the operation detail detecting unit 13 acquires the details of an operation performed on the operation device 21.

In step ST14, the area specifying unit 14 specifies the split area including the position of the operation device 21 detected by the position detecting unit 11 by using the pieces of area information acquired by the attribute acquiring unit 12.

In step ST15, the action specifying unit 15 specifies an action corresponding to the operation details detected by the operation detail detecting unit 13 by using the attribution information for the split area specified by the area specifying unit 14. The action specifying unit 15 outputs information indicating the specified action to the HMI control unit 31, and causes the HMI control unit 31 to perform the action.

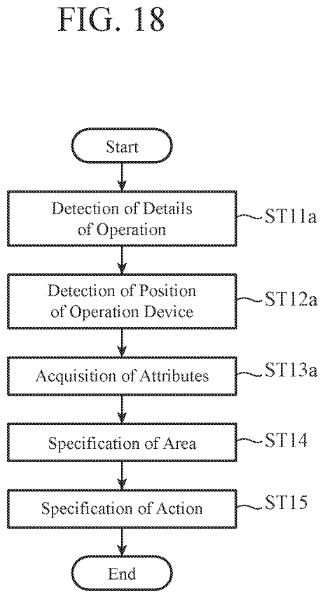

FIG. 18 is a flow chart explaining an example of the operation of the input control device 10 according to Embodiment 1, and shows a case in which the operation device 21 shown in FIG. 4 or 6 is used. The input control device 10 repeatedly performs the operation shown in the flow chart of FIG. 18.

In step ST11a, the operation detail detecting unit 13 detects the details of an operation performed on the operation device 21.

In step ST12a, the position detecting unit 11 detects the position of the operation device 21 on the display 42 equipped with the touch sensor 22 on the basis of the locus of the single contact portion when the operation device 21 is operated, the contact portion being included in this operation device 21.

In step ST13a, the attribute acquiring unit 12 acquires the pieces of area information indicating the multiple split areas into which the screen of the display 42 equipped with the touch sensor 22 is split, and the attribution information for each of the multiple split areas from the area splitting unit 36 of the HMI control unit 31.

The operations in steps ST14 and ST15 are the same as those in steps ST14 and ST15 shown in the flow chart of FIG. 17.

As mentioned above, the input control device 10 according to Embodiment 1 includes the position detecting unit 11, the attribute acquiring unit 12, the operation detail detecting unit 13, the area specifying unit 14, and the action specifying unit 15. The position detecting unit 11 detects the position of the operation device 21 on the display 42 equipped with the touch sensor 22. The attribute acquiring unit 12 acquires the pieces of area information indicating the respective multiple split areas into which the screen of the display 42 equipped with the touch sensor 22 is split, and the attribution information for each of the multiple split areas. The operation detail detecting unit 13 detects the details of an operation performed on the operation device 21. The area specifying unit 14 specifies the split area including the position of the operation device 21 detected by the position detecting unit 11 by using the pieces of area information acquired by the attribute acquiring unit 12. The action specifying unit 15 specifies an action corresponding to the operation details detected by the operation detail detecting unit 13 by using the attribution information corresponding to the split area specified by the area specifying unit 14. This structure makes it possible for the input control device 10 not to require a complicated operation, such as an operation of separately manipulating an upper layer device and a low layer device like conventional operations, and also makes it possible to easily switch between multiple actions by using the single operation device 21. Further, because the position of the operation device 21 and content currently being displayed on the screen of the display 42 equipped with the touch sensor 22 do not necessarily have to be linked to each other, unlike in the case of conventional devices, the input control device 10 can switch to an action that is unrelated to the content currently being displayed on the screen.

### Embodiment 2

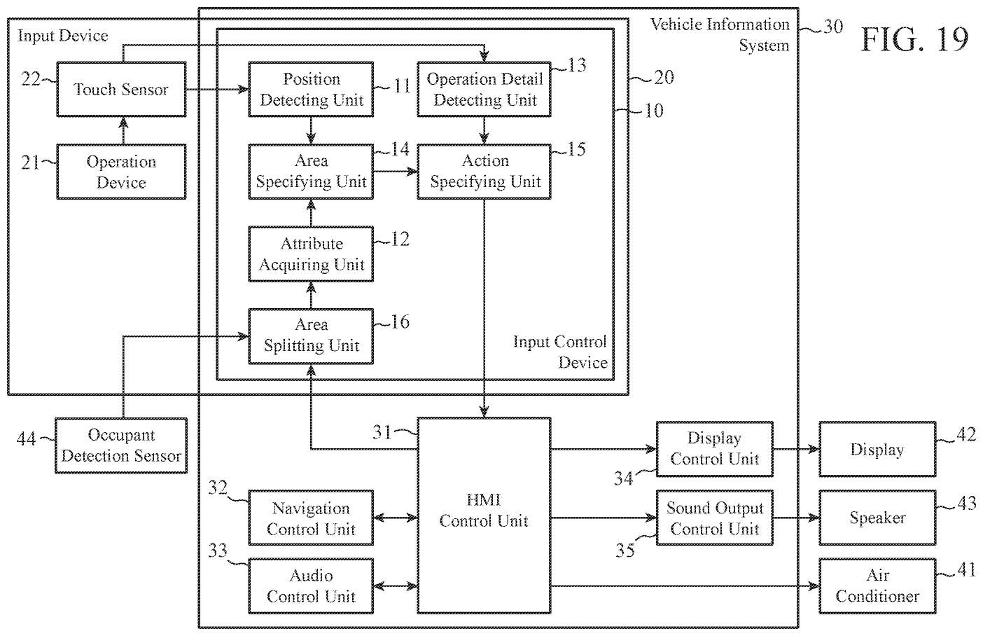

FIG. 19 is a block diagram showing an example of the configuration of a vehicle information system 30 according to Embodiment 2.

The vehicle information system 30 according to Embodiment 1 is configured in such a way that the HMI control unit 31 includes the area splitting unit 36. In contrast with this, the vehicle information system 30 according to Embodiment 2 is configured in such a way that an input control device 10 includes an area splitting unit 16 corresponding to the area splitting unit 36. In FIG. 19, components which are the same as or corresponding to those shown in FIG. 1 are denoted by the same reference signs, and an explanation of the components will be omitted hereinafter.

The area splitting unit 16 acquires information indicating content to be displayed on the screen of a display 42 equipped with a touch sensor 22 from an HMI control unit 31. The information indicating the content to be displayed on the screen includes display content as shown in FIG. 12 or the display position, the size, etc. of a display object as shown in FIG. 13. The area splitting unit 16 splits the screen on the basis of the content to be displayed on the screen of the display 42 equipped with the touch sensor 22, generates area information and attribution information for each of split areas, and outputs the generated area information and the generated attribution information to an attribute acquiring unit 12, like the area splitting unit 36 of Embodiment 1. The area splitting unit 16 holds a table shown in FIG. 12 or 13 and splits the screen by reference to this table, for example. As previously explained, display content may be or do not have to be in agreement with attributes. Further, the area splitting unit 16 may receive a result of occupant detection from an occupant detection sensor 44, and set a split area only for a seat where an occupant is sitting in accordance with the position of the seat.

Next, the operation of the input control device 10 according to Embodiment 2 will be explained.

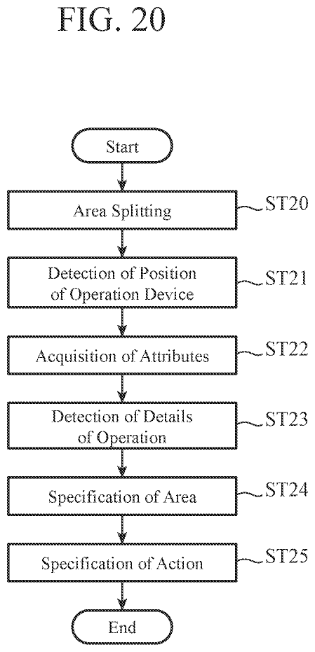

FIG. 20 is a flow chart explaining an example of the operation of the input control device 10 according to Embodiment 2, and shows a case in which an operation device 21 shown in FIG. 2, 3, or 5 is used. The input control device 10 repeatedly performs the operation shown in the flow chart of FIG. 20.

In step ST20, the area splitting unit 16 splits the screen of the display 42 equipped with the touch sensor 22 into multiple split areas, and assigns attribution information to each of the multiple split areas.

In step ST21, a position detecting unit 11 detects the position of the operation device 21 on the display 42 equipped with the touch sensor 22 on the basis of the positions of multiple contact portions that the operation device 21 includes.

In step ST22, the attribute acquiring unit 12 acquires the pieces of area information indicating the multiple split areas into which the screen of the display 42 equipped with the touch sensor 22 is split, and the attribution information for each of the multiple split areas from the area splitting unit 16.

In step ST23, an operation detail detecting unit 13 acquires details of an operation performed on the operation device 21.

In step ST24, an area specifying unit 14 specifies in which one of the multiple split areas after splitting by the area splitting unit 16 the position of the operation device 21 detected by the position detecting unit 11 is included.

In step ST25, an action specifying unit 15 specifies an action corresponding to the operation details detected by the operation detail detecting unit 13 by using the attribution information for the split area specified by the area specifying unit 14. The action specifying unit 15 outputs information indicating the specified action to the HMI control unit 31, and causes the HMI control unit 31 to perform the action.

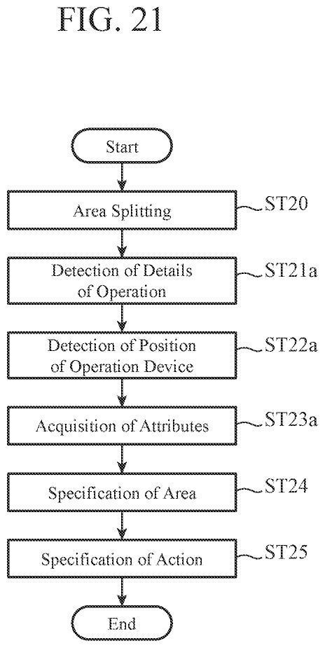

FIG. 21 is a flow chart explaining an example of the operation of the input control device 10 according to Embodiment 2, and shows a case in which an operation device 21 shown in FIG. 4 or 6 is used. The input control device 10 repeatedly performs the operation shown in the flow chart of FIG. 21.

Operations in steps ST20, ST24, and ST25 are the same as those in steps ST20, ST24, and ST25 shown in the flow chart of FIG. 20.

In step ST21a, the operation detail detecting unit 13 acquires the details of an operation performed on the operation device 21.

In step ST22a, the position detecting unit 11 detects the position of the operation device 21 on the display 42 equipped with the touch sensor 22 on the basis of the locus of the single contact portion when the operation device 21 is operated, the contact portion being included in this operation device 21.

In step ST23a, the attribute acquiring unit 12 acquires the pieces of area information indicating the multiple split areas into which the screen of the display 42 equipped with the touch sensor 22 is split, and the attribution information for each of the multiple split areas from the area splitting unit 16.

As mentioned above, the input control device 10 according to Embodiment 2 includes the area splitting unit 16 that splits the screen of the display 42 equipped with the touch sensor 22 into multiple split areas, and assigns attribution information to each of the multiple split areas. The attribute acquiring unit 12 acquires the pieces of area information indicating the respective multiple split areas after splitting, and the attribution information for each of the multiple split areas from the area splitting unit 16. The area specifying unit 14 specifies in which one of the multiple split areas after splitting by the area splitting unit 16 the position of the operation device 21 detected by the position detecting unit 11 is included. As a result, the input control device 10 can assign multiple actions to the single operation device 21. Further, the input control device 10 can assign an action that is unrelated to content displayed on the screen to each split area.

Further, the area splitting unit 16 of Embodiment 2 splits the screen of the display 42 equipped with the touch sensor 22 into multiple split areas in such a way that the multiple split areas correspond to the positions of multiple occupants sitting in a vehicle, as shown in FIG. 10 or 11. The area splitting unit 16 splits the area to be split in accordance with the actual positions of occupants, thereby making it possible for each occupant to grasp the occupant's split area corresponding to the application range more intuitively.

Further, the area splitting unit 16 of Embodiment 2 splits the screen of the display 42 equipped with the touch sensor 22 into multiple split areas in such a way that the multiple split areas correspond to the display areas of multiple display objects to be displayed on the screen, as shown in FIG. 8. The area splitting unit 16 splits the area to be split in accordance with the actual display objects, thereby making it possible for each occupant to operate the operation device 21 more intuitively.

Finally, the hardware configuration of the vehicle information system 30 according to each of the embodiments will be explained.

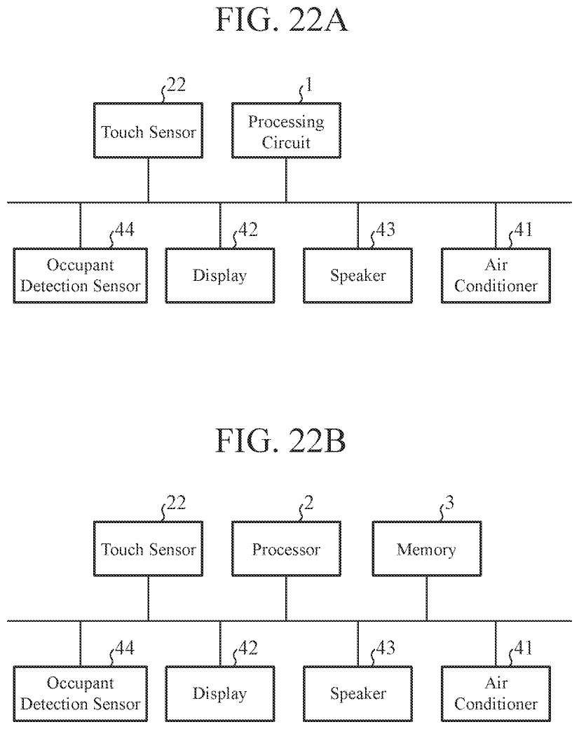

FIGS. 22A and 22B are diagrams showing examples of the hardware configuration of the vehicle information system 30 according to each of the embodiments. Each of the functions of the position detecting unit 11, the attribute acquiring unit 12, the operation detail detecting unit 13, the area specifying unit 14, the action specifying unit 15, the area splitting unit 16, the HMI control unit 31, the navigation control unit 32, the audio control unit 33, the display control unit 34, the sound output control unit 35, and the area splitting unit 36 in the vehicle information system 30 is implemented by a processing circuit. More specifically, the vehicle information system 30 includes a processing circuit for implementing each of the above-mentioned functions. The processing circuit may be a processing circuit 1 as hardware for exclusive use, or may be a processor 2 that executes a program stored in a memory 3. The processing circuit 1 or the processor 2 and the memory 3 are connected to the touch sensor 22, the air conditioner 41, the display 42, the speaker 43, and the occupant detection sensor 44.

In the case in which the processing circuit is hardware for exclusive use as shown in FIG. 22A, the processing circuit 1 is, for example, a single circuit, a composite circuit, a programmable processor, a parallel programmable processor, an application specific integrated circuit (ASIC), a field programmable gate array (FPGA), or a combination thereof. The functions of the position detecting unit 11, the attribute acquiring unit 12, the operation detail detecting unit 13, the area specifying unit 14, the action specifying unit 15, the area splitting unit 16, the HMI control unit 31, the navigation control unit 32, the audio control unit 33, the display control unit 34, the sound output control unit 35, and the area splitting unit 36 may be implemented by multiple processing circuits 1, or the functions of the units may be implemented collectively by a single processing circuit 1.

In the case in which the processing circuit is the processor 2 as shown in FIG. 22B, each of the functions of the position detecting unit 11, the attribute acquiring unit 12, the operation detail detecting unit 13, the area specifying unit 14, the action specifying unit 15, the area splitting unit 16, the HMI control unit 31, the navigation control unit 32, the audio control unit 33, the display control unit 34, the sound output control unit 35, and the area splitting unit 36 is implemented by software, firmware, or a combination of software and firmware. The software or the firmware is described as a program and the program is stored in the memory 3. The processor 2 implements the function of each of the units by reading and executing a program stored in the memory 3. More specifically, the vehicle information system 30 includes the memory 3 for storing a program by which the steps shown in the flow chart of FIG. 17 or the like are performed as a result when the program is executed by the processor 2. Further, it can be said that this program causes a computer to perform procedures or methods that the position detecting unit 11, the attribute acquiring unit 12, the operation detail detecting unit 13, the area specifying unit 14, the action specifying unit 15, the area splitting unit 16, the HMI control unit 31, the navigation control unit 32, the audio control unit 33, the display control unit 34, the sound output control unit 35, and the area splitting unit 36 use.

Here, the processor 2 is a central processing unit (CPU), a processing device, an arithmetic device, a microprocessor, a microcomputer, or the like.

The memory 3 may be a non-volatile or volatile semiconductor memory such as a random access memory (RAM), a read only memory (ROM), an erasable programmable ROM (EPROM), or a flash memory, may be a magnetic disc such as a hard disc or a flexible disc, or may be an optical disc such as a compact disc (CD) or a digital versatile disc (DVD). The table shown in FIG. 12 or the like is stored in the memory 3.

A part of the functions of the position detecting unit 11, the attribute acquiring unit 12, the operation detail detecting unit 13, the area specifying unit 14, the action specifying unit 15, the area splitting unit 16, the HMI control unit 31, the navigation control unit 32, the audio control unit 33, the display control unit 34, the sound output control unit 35, and the area splitting unit 36 may be implemented by hardware for exclusive use, and another part of the functions may be implemented by software or firmware. As mentioned above, the processing circuit in the vehicle information system 30 can implement each of the above-mentioned functions by using hardware, software, firmware, or a combination thereof.

It is to be understood that any combination of the embodiments can be made, various changes can be made in any component according to any one of the embodiments, and any component according to any one of the embodiments can be omitted within the scope of the present disclosure.

### INDUSTRIAL APPLICABILITY

Because the input control device according to the present disclosure makes it possible to easily switch between multiple actions by using a single operation device, the input control device is suitable for use as an input control device or the like that uses a CID or the like mounted in a vehicle.

### REFERENCE SIGNS LIST

1 processing circuit, 2 processor, 3 memory, 10 input control device, 11 position detecting unit, 12 attribute acquiring unit, 13 operation detail detecting unit, 14 area specifying unit, 15 action specifying unit, 16, 36 area splitting unit, 20 input device, 21 operation device, 21a rotation operation portion, 21b, 21c, 21d, 21f, 21n, 21o, 21q contact portion, 21e push operation portion, 21m frame portion, 21p slide operation portion, 22 touch sensor, 30 vehicle information system, 31 HMI control unit, 32 navigation control unit, 33 audio control unit, 34 display control unit, 35 sound output control unit, 41 air conditioner, 42 display, 43 speaker, 44 occupant detection sensor, 100 air conditioner temperature adjustment area, 101 AV volume control area, 102 driver's seat operation mode area, 103, 113 list area, 110 display object, 111 AV volume control area, 112, 120 list display object, 121 list left area, 122 list right area, 130, 140 driver's seat area, 131, 141 front seat area, 132 left rear seat area, and 133 right rear seat area.

1. An input control device comprising:
processing circuitry to
detect a position of an operation device on a touch-sensor-equipped display;
acquire pieces of area information indicating respective multiple split areas into which a screen of the touch-sensor-equipped display is split, and attribution information for each of the multiple split areas;
detect details of an operation performed on the operation device;
specify one of the split areas which includes the detected position of the operation device by using the pieces of area information acquired; and
specify an action corresponding to the detected details of the operation by using the attribution information corresponding to the split area specified.

2. The input control device according to claim 1, wherein the processing circuitry splits the screen of the touch-sensor-equipped display into the multiple split areas, and assigns each of the multiple split areas the corresponding attribution information,
the processing circuitry acquires the pieces of area information indicating the respective multiple split areas after splitting, and the attribution information for each of the multiple split areas, and
the processing circuitry specifies in which one of the multiple split areas after splitting the detected position of the operation device is included.

3. The input control device according to claim 2, wherein the touch-sensor-equipped display is to be mounted in a vehicle, and
the processing circuitry splits the screen of the touch-sensor-equipped display into the multiple split areas in such a way that the split areas correspond to positions of multiple occupants sitting in the vehicle.

4. The input control device according to claim 2, wherein the processing circuitry splits the screen of the touch-sensor-equipped display into the multiple split areas in such a way that the split areas correspond to display areas of multiple display objects to be displayed on the screen.

5. An input device comprising:
the touch-sensor-equipped display;
the operation device to be put on the touch-sensor-equipped display; and
the input control device according to claim 1.

6. An input control method comprising:
detecting a position of an operation device on a touch-sensor-equipped display;
acquiring pieces of area information indicating respective multiple split areas into which a screen of the touch-sensor-equipped display is split, and attribution information for each of the multiple split areas;
detecting details of an operation performed on the operation device;
specifying one of the split areas which includes the detected position of the operation device by using the pieces of area information acquired; and
specifying an action corresponding to the detected details of the operation by using the attribution information corresponding to the split area specified.
